(19) United States
(12) Patent Application Publication
(10) Pub. No.: US 2026/0014693 A1
(43) Pub. Date: Jan. 15, 2026

(54) MODULAR TOOL TRAY ORGANIZER

(71) Applicant: Jonathan Hurley, Columbia Falls, MT (US)

(72) Inventor: Jonathan Hurley, Columbia Falls, MT (US)

(21) Appl. No.: 18/770,501

(22) Filed: Jul. 11, 2024

(51) Int. Cl. B25H 3/06

(52) U.S. Cl. CPC B25H 3/06

(57) ABSTRACT

A modular tool tray organizer is composed of a plurality of rectilinear shaped base panels, each having side edges and a top surface. At least one first connection projection projects from at least a first side edge and at least one first socket is formed in at least a second side edge for receiving the at least one first connection projection of an adjacent base panel to form a flat base for the tray of a desired size and shape.

### BACKGROUND

For efficiency, workmen and mechanics assemble together in advance the tools needed to carry out a specific task. To this end, fixed-sized carrying trays are available. Such trays may have compartments for placing tools or other items, such as fasteners or hardware members. However, it would be desirable to be able to configure a tool organizing and carrying tray to hold specific tools and also optionally at specific locations on the tray to help keep track of the tools and not leave a tool at the work site. Also, it would be desirable to configure a tool organizing and carrying tray to a desired size and/or shape to accommodate all of the tools and hardware or other items needed for a task. These needs are sought to be addressed by the modular tool tray organizer of the present disclosure.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a modular tool tray organizer is provided. The modular tool tray organizer includes a plurality of rectilinear-shaped base panels comprising side edges, a top surface, at least one first connection projection projecting from at least a first side edge, at least one first socket formed in at least a second side edge for receiving the at least one first connection projection of an adjacent base panel, and two adjacent base panels interconnected by pressing the adjacent side edges of the adjacent base panels towards each other in a direction parallel to the top surfaces of the adjacent base panels to engage the at least one first connection projection into a first socket.

In any of the embodiments described herein, wherein the at least one first connection projection is disposed below the top surface of the base panel.

In any of the embodiments described herein, wherein the at least one first socket is sized and shaped to snuggly receive the at least one first connection projection.

In any of the embodiments described herein, wherein the at least one first connection projection is rectilinear in shape.

In any of the embodiments described herein, wherein the at least one first connection projection comprises a body portion and a tongue connected to and spaced from the body portion.

In any of the embodiments described herein, wherein the at least one first socket defining a hollow for receiving the tongue therein.

In any of the embodiments described herein, wherein the tongue is connected to the body portion at a flexible juncture with the body portion, the tongue flexing at the flexible juncture to engage the hollow, thereby to place the at least one first projection into locking relationship with the at least one first socket.

In any of the embodiments described herein, further comprising a sill extending along the margins of the hollow for support of the first projection.

In any of the embodiments described herein, wherein at least one second socket extending downwardly from the top surface of the base panel.

In any of the embodiments described herein, further comprising a tool holder configured to receive a mechanics tool, the tool holder comprising a downwardly extending second connection projection receivable into the least one second socket.

In any of the embodiments described herein, wherein the tool holder comprising spaced-apart upright sidewalls for receiving a mechanics tool between the side walls, and the downwardly extending second connection projection extending downwardly from the upright sidewalls.

In any of the embodiments described herein, wherein the tool holder comprising an upwardly projecting column, and wherein the downwardly extending second connection projection extending downwardly from the upwardly projecting column.

In any of the embodiments described herein, wherein the upwardly projecting column is configured to receive a mechanics tool socket.

In any of the embodiments described herein, further comprising a wall structure comprising a wall section and a second connection projection extending downwardly from the wall section to be receivable within a second socket of a base panel, with the wall section extending along the top surface of the base panel.

In any of the embodiments described herein, wherein the wall section is selected from the group including a straight wall section and a curved wall section.

In any of the embodiments described herein, further comprising a handle engageable with at least one base panel, the handle comprising a manually graspable section and at least one third connection projection extending from the manually graspable section to be receivable within a first socket.

In accordance with another embodiment of the present disclosure, a base panel is provided for forming a modular tool tray organizer. The base panel includes a rectilinear body portion having side edges and a top surface, at least one first connection projection projecting from at least a first side edge, and at least one first socket formed in at least a second side edge for receiving the at least one first connection projection of an adjacent body portion, wherein two adjacent base panels are interconnected by pressing the adjacent side edges of the adjacent base panels towards each other in a direction parallel to the top surfaces of the adjacent base panels to engage the at least one first connection projection into a first socket.

In any of the embodiments described herein, wherein the at least one first connection projection is disposed below the top surface of the body portion.

In any of the embodiments described herein, wherein the at least one first socket is sized and shaped to snuggly receive the at least one first connection projection.

In any of the embodiments described herein, wherein the at least one first connection projection is rectilinear in shape.

In any of the embodiments described herein, wherein the at least one first connection projection comprises a body portion and a tongue connected to and spaced from the body portion, the tongue configured to engage into locking relationship with the at least one first socket of an adjacent body portion.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of an assembled modular tool organizer tray 100 configured to hold various types of mechanics tools;

FIG. 2 shows a portion of the tray base formed by assembled base panels;

FIG. 3 is a cross-sectional view of FIG. 1, taken along lines 3-3 of FIG. 1;

FIG. 4A is an enlarged, exploded cross-sectional view of several base panels and mechanics tool holders;

FIG. 4B is a view of the components of FIG. 4A, showing the components assembled together;

FIG. 5A is a pictorial view of a base panel taken from above;

FIG. 5B is a pictorial view of the base panel of FIG. 5A taken from below;

FIG. 5C is a plan view of the base panel of FIG. 5A;

FIG. 5D is a side elevational view of the base panel of FIG. 5A;

FIG. 5E is a bottom view of the base panel of FIG. 5A.

### DETAILED DESCRIPTION

Various example embodiments of the present disclosure are described below with reference to the accompanying drawings in which some example embodiments are illustrated. In the figures, the thicknesses of lines, layers and/or regions may be exaggerated for clarity.

While example embodiments are capable of various modifications and alternative forms, embodiments thereof are shown by way of example in the figures and are described in detail below. It should be understood, however, that there is no intent to limit example embodiments to the particular forms disclosed, but on the contrary, example embodiments are to cover all modifications, equivalents, and alternatives falling within the scope of the disclosure.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be considered in the specific context this definition is given herein.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

The present application may include references to directions, such as “forward,” “rearward,” “front,” “back,” “ahead,” “behind,” “upward,” “downward,” “above,” “below,” “top,” “bottom,” “right hand,” left hand,” “in,” “out,” “extended,” “advanced,” “retracted,” “proximal,” “distal,” “central,” “vertical,” etc. These references and other similar references in the present application are only to assist in helping describe and understand the present invention and are not intended to limit the present invention to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out. If a quantitative value is needed to render the applicable parameter sufficiently definite, the applicable parameter is within five percent (5%) of the designated parameter value.

In the present application, the term “rectilinear” is used to designate a shape defined by straight lines that meet at right angles. Non-limiting examples of rectilinear shapes include squares, rectangles, crosses, u-shapes, angle shapes, etc.

Further, the term “mechanic's tools” may include all manner of tools used by mechanics, including, but not limited to, wrenches, pliers, screw drivers, sockets, socket wrenches, rachet wrenches, hex wrenches, etc.

In the following description, various embodiments of the present disclosure are described. In the following description and in the accompanying drawings, the corresponding systems assemblies, apparatus, and units may be identified by the same part number, but with an alpha suffix or by a prime (“′”) or double prime (“″”) or even a triple prime (“′”) designation. The descriptions of the parts/components of such systems assemblies, apparatus, and units that are the same or similar are not repeated so as to avoid redundancy in the present application.

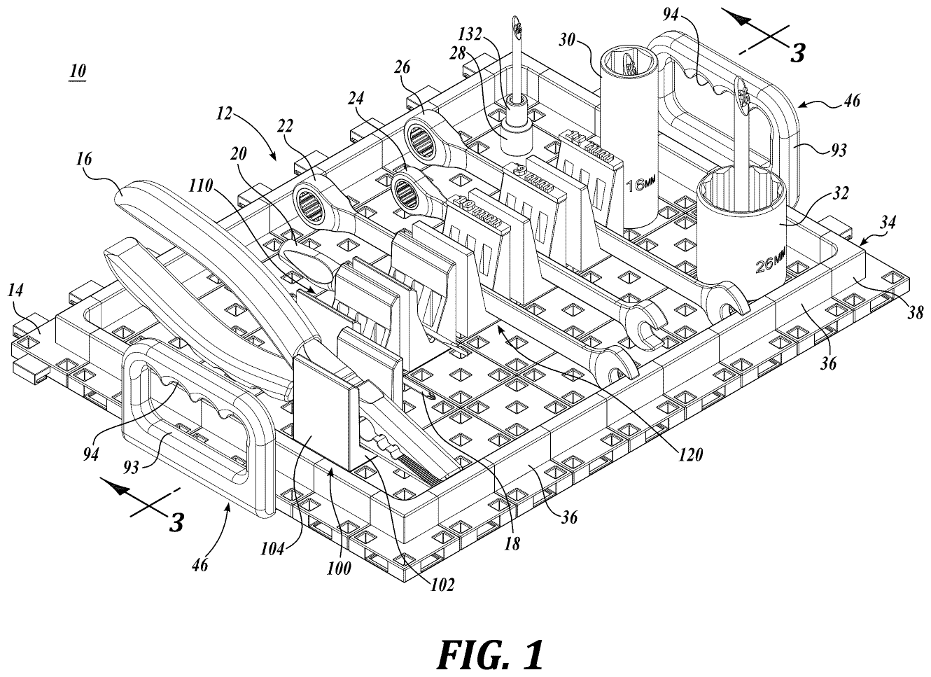

Referring initially to FIGS. 1-3, in one embodiment of the present disclosure, a tray assembly 10 includes in basic form a tray base 12 composed of individual base panels 14 that are “snap fit” or otherwise locked together to form the base 12 with sufficient strength and durability to hold a number of tools, such as mechanics tools, in an organized matter. Such mechanics tools can include, for example, pliers 16, screwdrivers 18 and 20, wrenches 22, 24, and 26, and sockets 28, 20, and 32. Each of these tools is held in place on the tray base 12 by tool holders secured to the tray base as discussed more fully below.

A wall 34 is shown as extending around the perimeter of the tray base 12. The perimeter wall 34 can be composed of longitudinal sections 36 and corner sections 38 that snuggly engage downwardly into openings or cavities or sockets 40 extending downward from the top surface 42 of the base panel 14. The perimeter wall 34 helps to retain smaller items as well as nuts, bolts, and other hardware or fasteners on the tray assembly 10.

Handles 46 are provided so that the tray assembly 10 can be conveniently carried about. The handles 46 also “snap fit” or otherwise lock with side openings, cavities, or sockets 48 formed in the sides of the base panels 14.

Although the forging briefly describes the basic construction of the tray assembly 10, it is to be understood that the tray assembly 10 need not include all of the above described elements. Rather, the tray assembly is defined by the claims of the present application. Further, it is to be understood that the configuration and construction of the base panel 14 constitutes a separate aspect of the present disclosure.

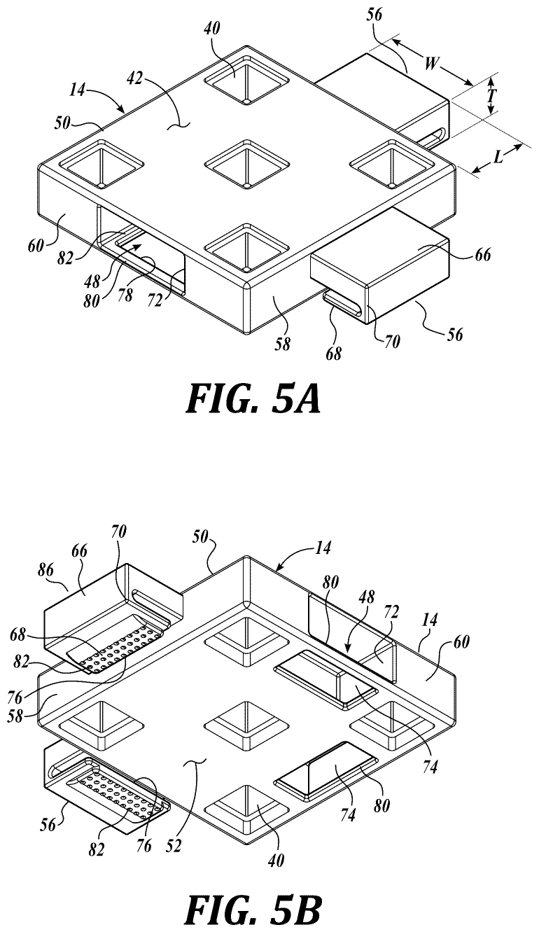

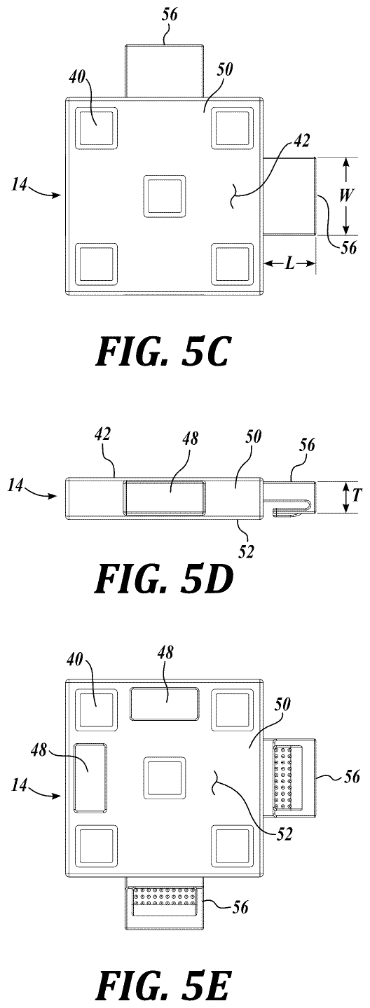

Discussing the construction of the tray assembly 10, in greater detail, as noted above, the tray base 12 of the tray assembly is constructed from individual base panels 14, see FIGS. 5A-5E. The base panel 14 is shown as being square in shape. However, the base panel can be of other shapes, including of other rectilinear shapes, such as rectangular, cross-shaped, U-shaped, and angle-shaped.

The tray base panel 14 includes a square-shaped body portion 50 with top openings or cavities or sockets 40 extending downwardly from the top surface 42 of the body portion. Although not essential, the sockets 40 extend all the way through the body portion so as to be open at the bottom surface 52 of the body portion.

The top sockets 40 are shown as being of square cross-sectional shape; however, the sockets 40 can be of other shapes, for example hexagonal or octagonal. Moreover, five sockets 40 are shown as formed in the tray base panel 14, one socket in the middle of the body portion 50, and a socket adjacent each corner of the body portion 50. However, it is to be understood that a greater number or a fewer number of sockets can be utilized. Further, the sockets can be in other locations than shown in FIGS. 5A-5E.

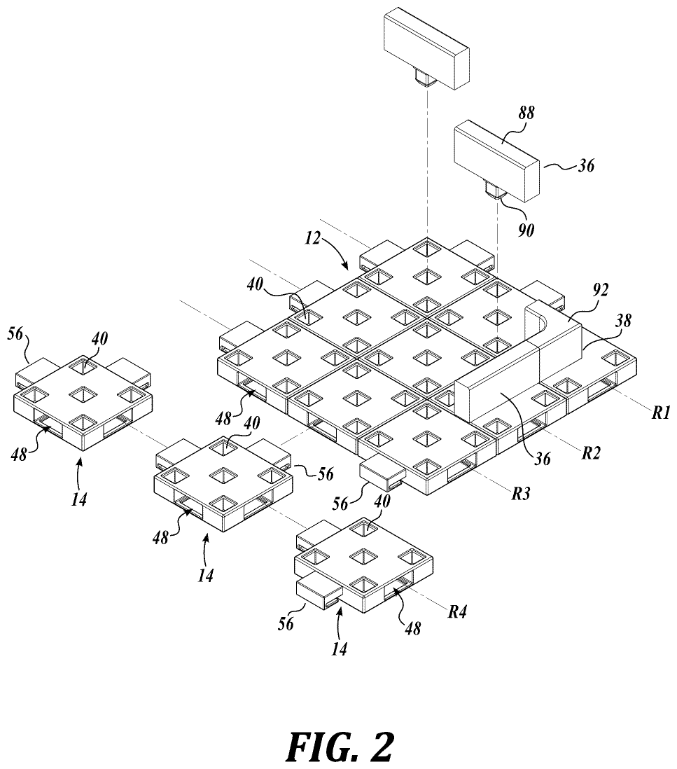

The tray base panels 14 are assembled and locked together to form a continuous tray base 12 of a desired shape and size. In this regard, connection projections 56 project from two adjacent side edges 58 of the body portion 50 to snuggly “snap fit” or otherwise lock into close fitting, correspondingly shaped side sockets 48 formed in the side edges 60 of adjacent base panels 14, see also FIG. 2. The connection projections 56 may be generally rectangular in shape, having a width W and a length L as well as a thickness T. Further, the connection projections 56 are constructed with an upper body portion 66 and the lower tongue portion 68 connected to the upper body portion 66 by a joint 70 that allows the tongue portion to flex relative the upper body portion 66.

The connection projections 56 are sized and shaped to be snuggly engageable into a close-fitting side socket 48 of an adjacent base panel 14, see FIG. 2. The side socket 48 has an opening 72 at the side edge 60 of the base panel and extends into the interior of the body portion 50. The side socket 48 also includes an opening or hollow 74 in the bottom surface 52 of the body portion 50 to receive the tongue portion in locking relationship. In this regard, the trailing edge 76 of the tongue portion 68 bears against edge 78 of the bottom opening or hollow 74 of the side socket 48 to lock the connection projection 56 into a side socket 48.

It will be appreciated that during the insertion of a connection projection 56 into a side socket 48, the tongue portion 68 flexes upwardly towards the underside of the body portion 66 due to the presence of the entry sill portion 80 extending across the side socket opening 72. Once the trailing edge 76 of the tongue portion 68 has slid past the entry sill 80, the tongue portion 48 can resume its nominal configuration, which places the trailing edge 76 of the tongue portion at the same elevation as the sill 80 and thus prevents the removal of the connection projection 56 from the side socket 48 due to the trailing edge 76 abutting the sill 80.

Bumps 82 or other forms of projections can extend downwardly from the bottom surface of the tongue portion 68 to facilitate the sliding of the tongue portion over the sill 80 with reduced friction relative to if the bottom surface of the tongue portion were smooth. Rather than utilizing bumps 82, ridges can extend along the bottom surface of the tongue portion 68 in the direction parallel to the direction of sliding movement of the tongue portion 68 into the side socket opening 72. Such ridges can also function to reduce the friction between the bottom surface of the tongue portion 68 and the sill 80.

The tray assembly can be disassembled or reconfigured by pressing upward on the underside of a tongue portion so that the tongue trailing edge is positioned above the corresponding sill 80, thereby unlocking the connection projection 56 from a corresponding side socket 48. This allows the connection projection 56 to be slidably disengaged from the corresponding side socket 48.

The upper surface of the body portion 66 of the connection projection 56 is spaced directly beneath the top surface 42 of the base panel. Likewise, the top of the side sockets 48 are correspondingly spaced below the top surface of the base panel. In this manner, the connection projection 56 is protected from the tools or other items being carried on the tray 10. This reduces the likelihood of damage caused to the connection projections. Also, the connection projections 56 are less likely to be subjected to dirt, grit, or other foreign substances that make it difficult to disengage a connection projection from a side socket when disassembling the tray assembly 10 or reconfiguring the tray assembly.

It will be appreciated that in the foregoing construction the base panels 14 are not only securely locked together, but also are maintained in coplanar relationship to each other so as to present a flat or planar top surface for the tray base 12. In this regard, the top surface of the body portion 66 of the connection projection 56 bears against the bottom surface of the top of the adjacent base panel 14 to which the base panel in question is connected. The top surface of the body portion 66 presents a large bearing surface for the top surface 42 of the adjacent base panel.

In addition, the sill 80 provides support for the underside of the body portion 66 of the connection projections. Further, side ledges 82 extend inwardly into the side socket from each end of the sill 80 to also provide support for the underside of the tongue portion 68, adding to the structural integrity of the interconnection between adjacent base panels 14.

Also, the rectilinear configuration of the connection projections 56 and the corresponding shape of the side sockets 48 prevent adjacent base panels from tilting or twisting relative to each other about an axis parallel to the direction that the connection projection 56 extends from its tray base 42.

Referring to FIG. 2, it will be appreciated that by constructing the base panels 14 with two connection projections 56 at adjacent side edges 58 of the body portion 50 and with two side sockets 48 at adjacent side edges 60, the base panels 14 can be conveniently assembled into desired configurations, sizes, and shapes. For example, the base panels 14 can be assembled into rows, such as rows R1, R2, R3, and R4 and then the rows assembled as a unit with adjacent rows.

FIGS. 2 and 5A-5E illustrate one form of a connecting tray base panels according to the present disclosure. However, the present disclosure is not limited to that illustrated in FIGS. 2 and 5A-5E. The connection projections 56 could be replaced with other structures. For example, the connection projections could be replaced with two or more rods or similar members that project from spaced apart locations of a side edge 58 of a base panel 14 to engage into close filling sockets formed in the adjacent side edge 60 of an adjacent base panel. This construction will also enable the base panels 14 to be not only locked together, but also maintained in coplanar relationship to each other.

Next referring specifically to FIGS. 1, 2, and 3, a perimeter wall 34 is shown as extending along the perimeter of the tray base 12. The perimeter wall 34 may be constructed from longitudinal sections 36 and corner sections 38. The longitudinal sections 36 may be constructed from elongate wall portions 88 and downward extending connection projections 90 that are sized and shaped to be closely and snuggly inserted into the top sockets 40. The intersection of the top sockets 40 and the top surface 42 of the base panel can be radiused or chamfered to guide the connection projection 90 down into the top sockets 40. The connection projections 90 are formed in a cross-sectional shape matching that of the top sockets 40 so that the wall portions 88 maintain a fixed orientation relative to the base panel 14 on which the perimeter wall is located.

The corner sections 38 are constructed similarly to the longitudinal sections 36, but with the exception that the wall portion 92 has two sections at right angles to each other to form a corner. As with the longitudinal sections 36, the corner sections 38 also include a downwardly extending connection projection 90 to be snugly receivable within a top socket 40.

It will be appreciated that the wall portions 88 and 92 are sized so that the longitudinal section 36 and corner sections 38 may form a continuous wall or edge on the tray base 12. Although the wall sections 36 and 38 are shown as sized to match the base panel on which they are mounted, the wall sections can be longer than a base panel. In this regard, the wall sections can be configured to be engageable with two of even a larger number of separate base panels 14.

Although the longitudinal sections 36 and corner sections 38 are shown in FIG. 1 to form a perimeter wall 34, such sections can instead be used to form one or more dividing walls extending across or along the tray base. In this manner, the tray base can be divided into sections or areas in which particular items may be stored, such as, for example, hardware of a certain size and/or type or fasteners of a certain size and/or type.

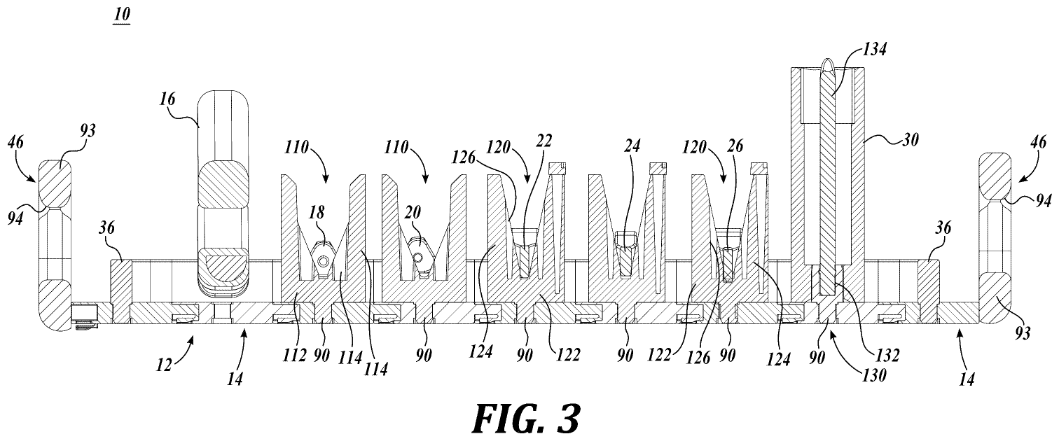

Referring to FIGS. 1 and 3, the tray assembly 10 also includes handles 46 to conveniently and securely hold the tray 10 when, for example, carrying the tray form place to place. The handles 46include a manually graspable frame 93 that extends upwardly from each end of the tray base 12. Finger grooves 94 can be provided under the top section of the frame to assist in securely holding the tray handle.

As shown in FIG. 3, the handles 46 include connection projections 56 for insertion into side sockets 48 of the base panel(s) 14 to which the handle 46 is attached. In this manner, the handles 46can be attached to the base panel(s) 14 in the same manner that base panels 14 are attached together, thereby providing s secure interconnection with adjacent base panels.

It is to be understood that the handles 46 can be of a desired length along the end of the tray assembly 10. The handles 46 are shown as connecting to base panels 14 with one base panel located between the connection base panels. However, the handles 46 can be of other lengths, and can be configured to connect to each base panel 14 located along the length of the handle.

As noted above, various configurations of tool holders can be used with the tray assembly 10 to hold different mechanics tools, for example, pliers, screw drives, wrenches, socket wrenches, sockets for socket wrenches, hammers, etc. As shown in FIGS. 1 and 3, a first holder 100 is configured to hold a pair of pliers 16. The holder 100 includes a base section 102 that rests on the top of the tray base. Spaced apart wall sections 104 extent upwardly from the base section 102 to receive the pliers therebetween.

A connection projection 90 extends downward from the underside of the base section 102 to be snuggly receivable within top socket 40 of a base panel 14. The connection projection 90 can be inserted into a desired top socket 40 so as to position the holder 100 on the tray 10, and thus place the pliers 16 at a desired location on the tray 10. Such location may depend on, for example, the size of the pliers, the size of the tray assembly 10, as well the desired location relative to the other tools being held and organized on the tray assembly.

Holders 100 can be of various sizes for holding different sizes and types of tools in addition to pliers, for example, the handle of a hammer or mallet or a tube of caulk or a caulking gun. In this regard, the distance separating the upright wall sections 104 can be altered, as well as the height and length of the upright wall sections. Further the base section 102 can be curved to correspond to the curvature of a hammer or mallet handle or the diameter of a tube of caulk.

As shown in FIGS. 1 and 3, holders 110 are shown as holding screwdrivers 18 and 20 on tray 10. The holders 110 include a base section 112 that rests on the top of the tray base. Spaced-apart wall sections 114 extend upwardly from the base section 112 to receive the shanks of the screwdrivers 18 and 20 therebetween. Diagonal webs or ramps 116 extend upwardly along the insides of the wall sections to define a generally V-shaped channel to closely receive the shanks of the screwdrivers.

A connection projection 90 extends downward from the underside of the base section 112 to be snuggly receivable within top socket 40 of a base panel 14. The connection projection 90 can be inserted into a desired top socket 40 so as to position the holders 110 on the tray 10, and thus place the pliers screw drivers at desired locations on the tray 10. Such locations may depend on, for example, the size of the screwdrivers, the size of the tray assembly 10, as well the desired location of the screwdrivers relative to the other tools being held and organized on the tray assembly.

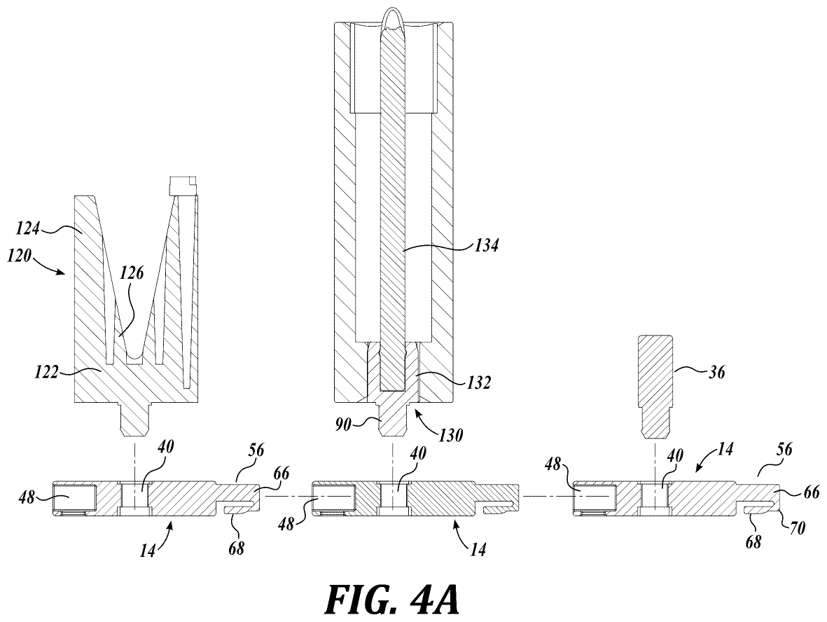

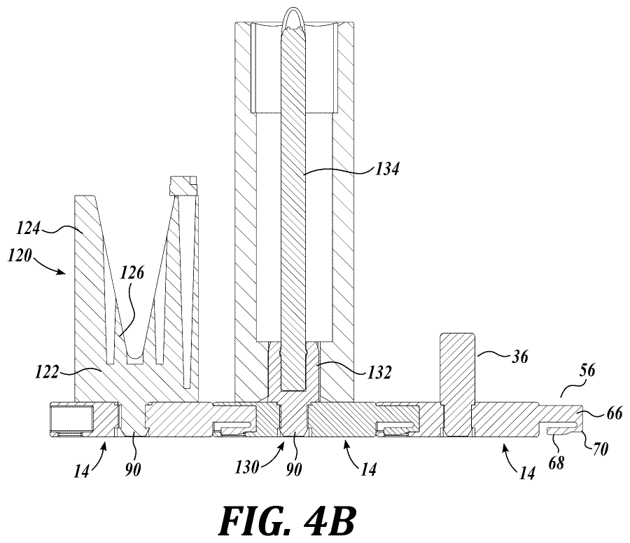

As shown in FIGS. 1, 3, 4A, and 4B, holders 120 are shown as holding wrenches 22, 24, and 26 on tray 10. The holders 120 include a base section 122 that rests on the top of the tray base. Spaced apart wall sections 124 extend upwardly from the base section 122 to receive the wrenches 22, 24, and 26 therebetween. Diagonal or sloped webs or ramps 126 extend upwardly along the insides of the wall sections 124 to define a generally Vee shaped channel to closely receive the shanks or handles of the wrenches 22, 24, and 26.

A connection projection 90 extends downward from the underside of the base section 122 to be snuggly receivable within top socket 40 of a base panel 14. The connection projection 90 can be inserted into a desired top socket 40 so as to position the holders 120 on the tray 10, and thus place the wrenches 22, 24, and 26 at desired locations on the tray 10. Such locations may depend on, for example, the size of the wrenches, the size of the tray assembly 10, as well the desired locations of the wrenches relative to the other tools being held and organized on the tray assembly 10.

As shown in FIGS. 1, 3, 4A, and 4B, holders 130 are shown as holding sockets 28, 30, and 32 on tray 10. The holders 130 include a base section 132 that rests on the top of the tray base. The base section is size and shaped to receive (engage into) the head of the socket, which typically has a through hole that is square in cross section to receive the tang or drive gear projecting from the head of a rachet wrench. The tang or drive gear may be of different sizes, for example, ¼ inch, ⅜ inch, or ½ inch across.

The holders 130 may include a shaft 134 that projects upwardly from the base section to serve as a lead in for the sockets, Also base section 132 may be formed with a connection projection 90 that extends downward from the underside of the base section 132 to be snuggly receivable within top socket 40 of a base panel 14. The connection projection 90 can be inserted into a desired top socket 40 so as to position the holders 130 on the tray 10, and thus place the sockets 28, 30, and 32 at desired locations on the tray 10. Such locations may depend on, for example, the sizes and numbers of sockets, the size of the tray assembly 10, as well the desired location of the sockets relative to the other tools being held and organized on the tray assembly.

While illustrative embodiments have been illustrated and described, it will be appreciated that various changes can be made therein without departing from the spirit and scope of the invention. For example, connection projections, such as a connection projection similar to 56, can be constructed with tongues located at the sides of the body portion, rather than at the bottom of the body portion.

Also, rather than using tongues similar to tongues 68 to lock the connection projection into engagement with an adjacent base panel, the connection projection can be constructed with teeth 9 (for example of a saw tooth shape) disposed along the bottom and/or sides of the body portion 66 to engage corresponding teeth located within the side sockets of the base panel body portion.

As another example, a dove tail or other type of projection can extend outwardly of and along the length of a side of base panel body portion 50 for sliding engagement into a socket extending into and along the side edge of an adjacent body portion 50 so that the corresponding base side edges are in face-to face-relationship to each other. Top sockets, similar to top sockets 40, can be provided for receiving the connection projection portions of tool holders. Handles can be constructed with projections or sockets for engaging the base panels at the end of the tray base.

1. A modular tool tray organizer, comprising a plurality of rectilinear-shaped base panels interconnectable together in locking relationship, the modular tray organizer comprising:
side edges,
a top surface,
at least one first male connector structure projecting from at least a first side edge,
at least one first female connector structure formed in at least a second side edge for receiving the at least one first male connector structure of an adjacent base panel, and
wherein the at least one first male connector structure comprises a body portion and a projection integrally formed with and extending from the body portion and the at least one first female connector structure configured for engaging the projection of the first male connector structure in locking relationship.

2. The modular tool tray organizer according to claim 1, wherein the at least one first male connector structure is disposed below the top surface of the base panel.

3. The modular tool tray organizer according to claim 1, wherein the at least one first female connector structure is sized and shaped to snuggly receive the at least one first male connector structure.

4-8. (canceled)

9. The modular tool tray organizer according to claim 1, at least one socket extending downwardly from the top surface of the base panel.

10. The modular tool tray organizer according to claim 9, further comprising a tool holder configured to receive a mechanics tool, the tool holder comprising a downwardly extending second connection projection receivable into the least one socket.

11. The modular tool tray organizer according to claim 10, wherein the tool holder comprising spaced-apart upright sidewalls for receiving a mechanics tool between the side walls, and the downwardly extending second connection projection extending downwardly from the upright sidewalls.

12. The modular tool tray organizer according to claim 10, wherein the tool holder comprising an upwardly projecting column, and wherein the downwardly extending second connection projection extending downwardly from the upwardly projecting column.

13. The modular tool tray organizer according to claim 12, wherein the upwardly projecting column is configured to receive a mechanics tool socket.

14. The modular tool tray organizer according to claim 1, further comprising a wall structure comprising a wall section and a second connection projection extending downwardly from the wall section to be receivable within a second socket of a base panel, with the wall section extending along the top surface of the base panel.

15. The modular tool tray organizer according to claim 14, wherein the wall section is selected from the group including a straight wall section and a curved wall section.

16. The modular tool tray organizer according to claim 1, further comprising a handle engageable with at least one base panel, the handle comprising a manually graspable section and at least one male connector structure extending from the manually graspable section to be receivable within a female connector structure of a base panel.

17. A base panel for forming modular tool tray organizer by interconnecting the base panel with at least one other base panel in locking relationship, the base panel comprising:
a rectilinear body having side edges and a top surface,
at least one first male connector structure projecting from at least a first side edge of the rectilinear body,
at least one first female connector structure formed in at least a second side edge of the rectilinear body for receiving the at least one first male connector structure of an adjacent base panel, and
wherein the at least one first male connector structure comprises a body portion and a projection integrally formed with the body portion and extending from the body portion and the at least one first female connector structure configured for engaging the projection of the first male connector structure in locking relationship.

18. The base panel according to claim 17, wherein the at least one first male connector structure is disposed below the top surface of the body portion.

19. The base panel according to claim 17, wherein the at least one first female connector structure is sized and shaped to snuggly receive the at least one first male connector structure.

20-21. (canceled)

22. The modular tool tray organizer according to claim 17, wherein the portions of the at least one female connector structure defining an abutment against the projection of the at least one first male connector structure to maintain the at least one first male connector structure in locking relationship with the at least one first female connector structure.

23. The modular tool tray organizer according to claim 1, wherein the portions of the at least one female connector structure defining an abutment against the projection of the at least one first male connector structure to maintain the at least one first male connector structure in locking relationship with the at least one first female connector structure.
